(19) United States
(12) Patent Application Publication
(10) Pub. No.: US 2025/0303876 A1
(43) Pub. Date: Oct. 2, 2025

(54) Solar Charging Vehicle Cover Arrangement

(71) Applicant: Charlie Jones, Cookeville, TN (US)

(72) Inventor: Charlie Jones, Cookeville, TN (US)

(21) Appl. No.: 18/621,313

(22) Filed: Mar. 29, 2024

(51) Int. Cl. B60L 8/00; B60L 53/16; H02S 30/20

(52) U.S. Cl. CPC B60L 8/003; B60L 53/16; H02S 30/20

(57) ABSTRACT

A solar charging vehicle cover arrangement includes a vehicle cover, an electrical connection arrangement, and a connection panel. The vehicle cover is designed to be draped over and cover a substantial portion of an electric vehicle. The vehicle cover includes a base layer and a solar collection layer positioned on top of the base layer. The electrical connection arrangement is designed to operatively connect the solar collection layer to a charging port of an electric vehicle. The connection panel is attached to the vehicle cover and designed and positioned to connect the vehicle cover to the electrical connection arrangement. An owner of an electric vehicle can use the solar charging vehicle cover arrangement to recharge the battery of the electric vehicle with electricity from solar energy collected by the solar charging vehicle cover arrangement.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to solar chargers for electric vehicles and more particularly pertains to a new solar charging vehicle cover arrangement for providing owners of electric vehicles, such as cars and trucks, with a way to charge their electric vehicles with solar energy while also protecting their cars from the elements.

### (2) Description of Related Art Including Information Disclosed Under 37 CFR 1.97 and 1.98

The prior art relates to solar chargers for electric vehicles. The prior art, as best understood, does not disclose solar charging vehicle cover arrangement designed to cover and protect an electric vehicle, such as a car or truck, from the elements and also collect solar energy to charge the rechargeable batteries of the electric vehicle.

### BRIEF SUMMARY OF THE INVENTION

An embodiment of the disclosure meets the needs presented above in a solar charging vehicle cover arrangement generally comprising a vehicle cover, an electrical connection arrangement, and a connection panel. The vehicle cover is designed to be draped over and cover a substantial portion of an electric vehicle. The vehicle cover includes a base layer and a solar collection layer positioned on top of the base layer. The electrical connection arrangement is designed to operatively connect the solar collection layer to a charging port of an electric vehicle. The connection panel is attached to the vehicle cover and designed and positioned to connect the vehicle cover to the electrical connection arrangement. An owner of an electric vehicle can use the solar charging vehicle cover arrangement to recharge the battery of the electric vehicle with electricity from solar energy collected by the solar charging vehicle cover arrangement.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a solar charging vehicle cover arrangement according to an embodiment of the disclosure in use.

FIG. 2 is a view of a portion of an embodiment of the disclosure.

FIG. 3 is a front view of an embodiment of the disclosure in use.

FIG. 4 is a cross-sectional view of a portion of an embodiment of the disclosure in use.

### DETAILED DESCRIPTION OF THE INVENTION

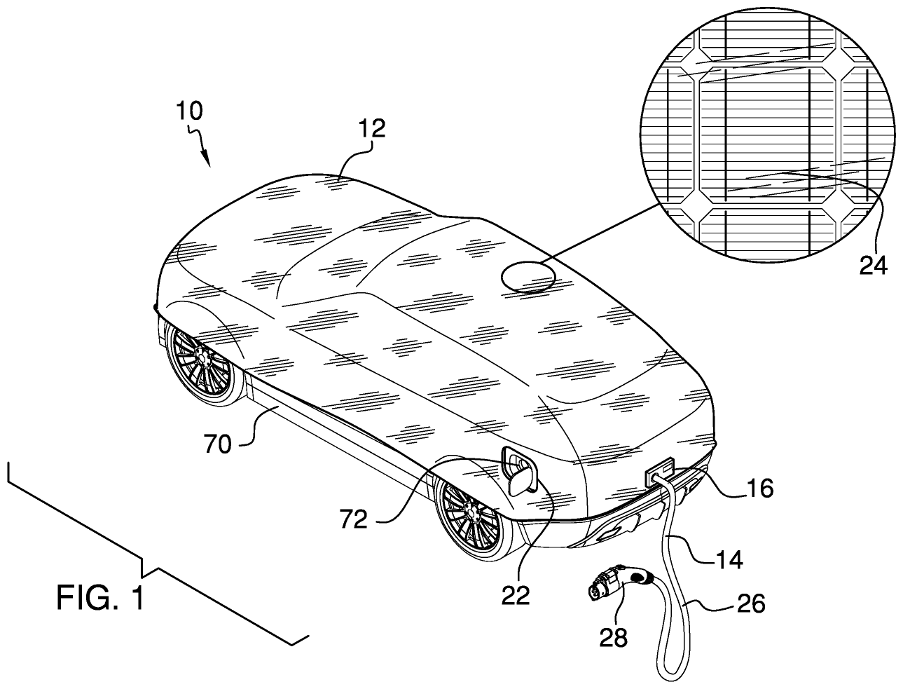

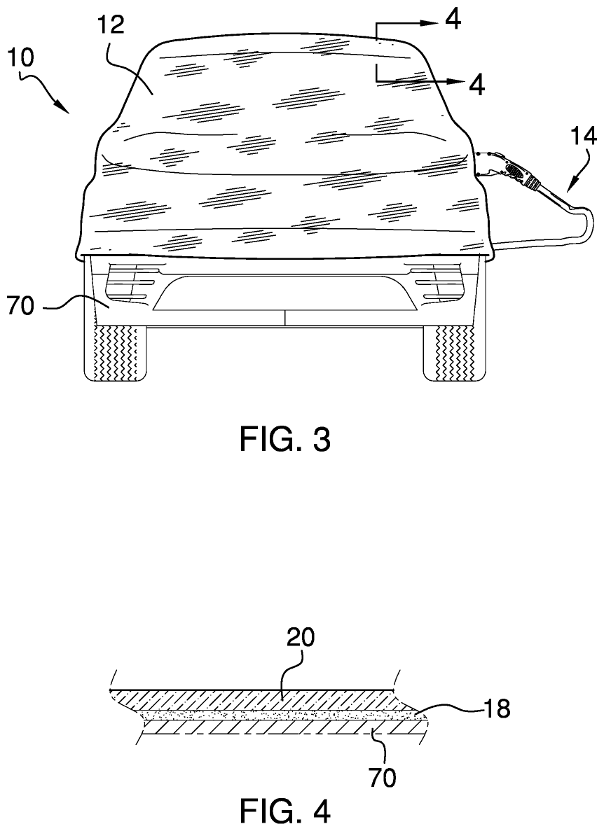

With reference now to the drawings, and in particular to FIGS. 1 through 4 thereof, a new solar charging vehicle cover arrangement embodying the principles and concepts of an embodiment of the disclosure and generally designated by the reference numeral 10 will be described.

As best illustrated in FIGS. 1 through 4, the solar charging vehicle cover arrangement 10 generally comprises a vehicle cover 12, an electrical connection arrangement 14, and a connection panel 16. The vehicle cover 12 is designed to be draped over and cover a substantial portion of an electric vehicle 70. As seen in FIG. 4, the vehicle cover 12 includes a base layer 18 and a solar collection layer 20 positioned on top of the base layer 18. The base layer 18 is designed to be placed in contact with outer surfaces of the electric vehicle 70. In one possible embodiment, the base layer 18 includes a microfiber material designed to engage and remove dirt and debris from outer surfaces of the electric vehicle 70 upon sliding removal of the vehicle cover 12 off of the electric vehicle 70. In other words, every time the owner removes the vehicle cover 12, the owner inherently wipes off the outer surfaces of the electric vehicle 70. As seen in FIG. 1, the vehicle cover 12 also includes an orifice 22 designed to be positioned over a charging port 72 of the electric vehicle 70 to permit access to the charging port 72 upon the vehicle cover 12 covering the electric vehicle 70.

The solar collection layer 20 includes solar cells 24 designed to collect and convert solar energy to electricity. The solar cells 24 can be positioned across the entirety of the solar collection layer 20 to maximize surface area exposed to the sun to maximize collection of solar energy.

The electrical connection arrangement 14 is designed to operatively connect the solar collection layer 20 to the charging port 72 of the electric vehicle 70. The electrical connection arrangement 14 includes a cable 26 and an electrical connector 28 designed to be connected to the charging port 72 of the electric vehicle 70 to permit transfer of electricity from the solar collection layer 20 to a battery of the electric vehicle 70. The cable 26 includes a first end 30 connected to the connection panel 16 to permit the transfer of electricity from the solar collection layer 20 to the cable 26. The cable 26 can either be wired into the connection panel 16 or detachably connected via a socket connection. The cable 26 includes a second end 32 connected to the electrical connector 28. The electrical connector 28 can be designed as a standard charging connector such as is used for electric vehicle charging stations or home use.

The connection panel 16 is attached to the vehicle cover 12 and designed and positioned to connect the vehicle cover 12 to the electrical connection arrangement 14. The connection panel 16 includes a charging gauge 34 designed to detect and display a current charge level of a rechargeable battery operatively connected to the charging gauge 34. The charging gauge 34 includes a display screen 36 designed to display a current charge level of a rechargeable battery as a percentage of a full charge, which may be represented by a graphic, a number, or a combination of a graphic and a number. The connection panel 16 is attached adjacent an edge portion of the vehicle cover 12 designed to be positioned at a rear end portion of the electric vehicle 70. However, the connection panel 16 may be attached to other portions of the vehicle cover 12, provided that the connection panel 16 is sufficiently close to the charging port 72 of the electric vehicle 70 to permit the electrical connector 28 to be plugged into the charging port 72.

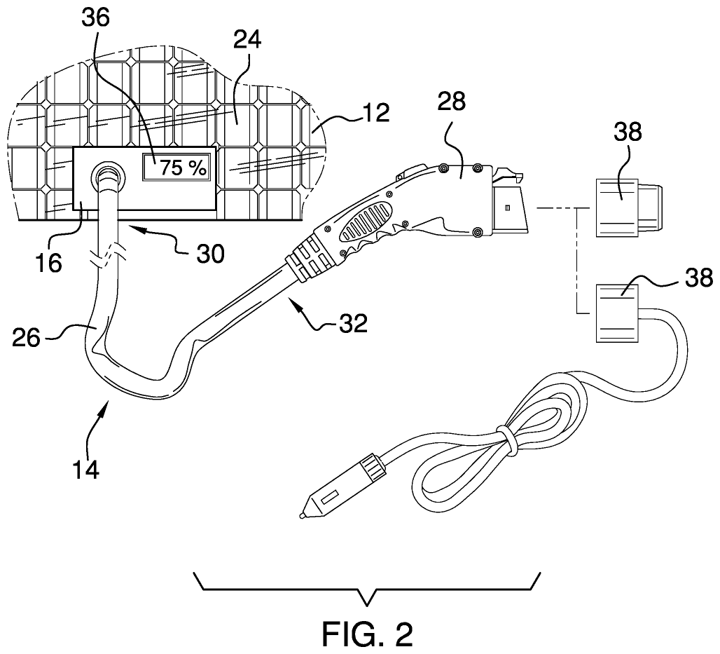

The solar charging vehicle cover 12 arrangement 10, as shown in FIG. 2, could further include a plurality of adapters 38 designed to adapt the electrical connector 28 to connect to charging ports 72 of electrical devices other than an electrical vehicle. The adapters 38 could allow a user to charge rechargeable batteries of other electric or electronic devices using the solar charging vehicle cover 12 arrangement 10.

In order to use the solar charging vehicle cover 12 arrangement 10, the user simply drapes the vehicle cover 12 over the electric vehicle 70, as shown in FIG. 1, with the orifice 22 aligned with the charging port 72. The user then plugs the electrical connector 28 into the charging port 72. The user can then allow the electric vehicle 70 to sit outside, such as in a driveway or parking lot, and passively collect solar energy while the user does other activities, such as working or engaging in household activities. When the user is ready to use the electric vehicle 70, the user disconnects the electrical connector 28 and removes the vehicle cover 12. The user can then fold up the vehicle cover 12 and place it in storage, such as in a building or the trunk of the electric vehicle 70.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar charging vehicle cover arrangement comprising:
a vehicle cover being configured to be draped over and cover a substantial portion of an electric vehicle; said vehicle cover comprises a base layer and a solar collection layer disposed on top of said base layer;
an electrical connection arrangement being configured to operatively connect said solar collection layer to a charging port of an electric vehicle; and
a connection panel being attached to said vehicle cover and configured and disposed to connect said vehicle cover to said electrical connection arrangement.

2. The solar charging vehicle cover arrangement of claim 1, wherein:
said base layer is configured to be placed in contact with outer surfaces of an electric vehicle; and
said base layer comprises a microfiber material configured to engage and remove dirt and debris from outer surfaces of an electric vehicle upon sliding removal of the vehicle cover off of an electric vehicle.

3. The solar charging vehicle cover arrangement of claim 1, wherein said solar collection layer comprises solar cells configured to collect and convert solar energy to electricity.

4. The solar charging vehicle cover arrangement of claim 3, wherein said solar cells are disposed across the entirety of said solar collection layer to maximize surface area exposed to the sun to maximize collection of solar energy.

5. The solar charging vehicle cover arrangement of claim 1, wherein said vehicle cover comprises an orifice configured to be disposed over a charging port of an electric vehicle to permit access to a charging port upon said vehicle cover covering an electric vehicle.

6. The solar charging vehicle cover arrangement of claim 1, wherein:
said electrical connection arrangement comprises a cable and an electrical connector configured to be connected to a charging port of an electric vehicle to permit transfer of electricity from said solar collection layer to a battery of an electric vehicle;
said cable comprises a first end connected to said connection panel to permit the transfer of electricity from said solar collection layer to said cable; and
said cable comprises a second end connected to said electrical connector.

7. The solar charging vehicle cover arrangement of claim 6, further comprising a plurality of adapters configured to adapt said electrical connector to connect to charging ports of electrical devices other than an electrical vehicle.

8. The solar charging vehicle cover arrangement of claim 1, wherein:
said connection panel comprises a charging gauge configured to detect and display a current charge level of a rechargeable battery operatively connected to said charging gauge; and
said charging gauge comprises a display screen configured to display a current charge level of a rechargeable battery as a percentage of a full charge represented by a graphic, a number, or a combination of a graphic and a number.

9. The solar charging vehicle cover arrangement of claim 1, wherein said connection panel is attached adjacent an edge portion of said vehicle cover configured to be disposed at a rear end portion of an electric vehicle.

10. A solar charging vehicle cover arrangement comprising:
a vehicle cover being configured to be draped over and cover a substantial portion of an electric vehicle; said vehicle cover comprises a base layer and a solar collection layer disposed on top of said base layer; wherein said base layer is configured to be placed in contact with outer surfaces of an electric vehicle; said base layer comprises a microfiber material configured to engage and remove dirt and debris from outer surfaces of an electric vehicle upon sliding removal of the vehicle cover off of an electric vehicle; said solar collection layer comprises solar cells configured to collect and convert solar energy to electricity; said solar cells are disposed across the entirety of said solar collection layer to maximize surface area exposed to the sun to maximize collection of solar energy; said vehicle cover comprises an orifice configured to be disposed over a charging port of an electric vehicle to permit access to a charging port upon said vehicle cover covering an electric vehicle;
an electrical connection arrangement being configured to operatively connect said solar collection layer to a charging port of an electric vehicle; said electrical connection arrangement comprises a cable and an electrical connector configured to be connected to a charging port of an electric vehicle to permit transfer of electricity from said solar collection layer to a battery of an electric vehicle; said cable comprises a first end connected to said connection panel to permit the transfer of electricity from said solar collection layer to said cable; said cable comprises a second end connected to said electrical connector; and
a connection panel being attached to said vehicle cover and configured and disposed to connect said vehicle cover to said electrical connection arrangement; said connection panel comprises a charging gauge configured to detect and display a current charge level of a rechargeable battery operatively connected to said charging gauge; said charging gauge comprises a display screen configured to display a current charge level of a rechargeable battery as a percentage of a full charge represented by a graphic, a number, or a combination of a graphic and a number; said connection panel is attached adjacent an edge portion of said vehicle cover configured to be disposed at a rear end portion of an electric vehicle.

11. The solar charging vehicle cover arrangement of claim 10, further comprising a plurality of adapters configured to adapt said electrical connector to connect to charging ports of electrical devices other than an electrical vehicle.
